(19) United States
(12) Patent Application Publication
(10) Pub. No.: US 2011/0099909 A1
(43) Pub. Date: May 5, 2011

(54) SLIDING DOOR

(76) Inventors: Wilfried Stommel, Ruppichteroth (DE); Jens Willach, Eitorf (DE)

(21) Appl. No.: 12/996,724

(22) PCT Filed: Jun. 10, 2009
(86) PCT No.: PCT/EP2009/057172

§ 371 Date: Dec. 7, 2010

(30) Foreign Application Priority Data
Jun. 14, 2008 (DE) 20 2008 008 006.1
Jan. 21, 2009 (DE) 10 2009 005 441.3

(51) Int. Cl. E05F 5/02; E05D 15/06

(52) U.S. Cl. 49/413

(57) ABSTRACT

The sliding door comprises a rail (10) with a door leaf guided thereon by way of a running device (13). The path of the door leaf is limited by a limiting device (15). The limiting device (15) forms an arm (31) together with an elongated coupler (30), said arm running parallel to the rail (10) and comprising a coupling part (32) for gripping together with the gripper part (17) of the damper (20). The coupling part (32) stands out laterally from the flat arm (31) so that no height adjustment of the coupling part or the gripper part is required when the height of the door leaf (12) changes.

The invention refers to a sliding door, in particular a glass sliding door, with a door leaf having a running device that is guided in a runner rail, a limiting device limiting the path of the door leaf, a damper with a soft-closing function, and coupling part interlocking with a gripper part of the damper, wherein, upon closing the door, the damper first slows down the door leaf and then drives the same in to the closed position.

It is known to provide sliding doors with a damper that slows down the closing movement before the end stop is reached so that a hard impact of the door leaf on the end stop is avoided. The damper absorbs the kinetic energy of the door leaf during the closing movement of the sliding door. However, such a damper does not guarantee that the door leaf reaches its exact closed position and remains there. It could happen that, when bumping against an end stop, the door leaf moves back again. Further, dampers are known which are additionally equipped with a spring pulling the gripper part of the damper toward the damper housing. With such a damper, which can be fixed both on the door leaf and the runner rail or the frame, it is achieved that the engagement of a coupling part at the gripper part of the damper triggers the damper. If the velocity of the door leaf is high, it is slowed down by the damping function of the damper. Thereafter, the tension force of the spring in the damper prevails. The same causes the door leaf to be smoothly driven into its end position against the damping force.

A general problem with sliding doors is the mutual adaptation of those components that are connected with the runner rail, i.e. the stationary components, and those components that are connected with the door leaf. Great care has to be taken upon assembly, so as to achieve that, with a cam-controlled damper, the closed position of the door leaf is reached exactly, which requires an accurate matching of the positions of the gripper part and the coupling part. If these positions are not observed exactly when the sliding door is assembled, posterior adjustment is very troublesome and sometimes impossible.

It is an object of the present invention to provide a sliding door of simplified assembly or installation, wherein erroneous matching is virtually impossible.

The sliding door of the present invention is defined in claim 1. It is characterized in that the limiting device forms a structural unit together with the coupler or the damper, and that the coupler has an arm extending in parallel to the runner rail, the arm comprising a coupling part for interengaging with the gripper part of the damper.

According to a first version of the invention, the limiting device that forms an end stop is combined into a structural unit with the coupler that causes the triggering of the damper during the sliding movement, the structural unit being adapted for being mounted to the runner rail in its entirety. According to a second version, the limiting device and the damper are combined into a unit mounted to the door frame. Thereby, the positions of the end stop and the coupling part or the gripper part are defined with respect to each other and are fixed so that faulty bores or other erroneous mounting cannot lead to errors or inaccuracies. When being mounted or prepared, the structural unit is fixed only to the runner rail. The structural unit bridges the distance from its position of mounting to the triggering point. The triggering point is the point at which the coupling part acts on the gripper part of the damper to release the same from its locked position. The triggering operation first starts the damping operation, whereafter the door leaf is pushed towards the end stop.

According to a preferred embodiment of the invention, the arm extending in parallel with the runner rail is a flat arm which may be formed, for instance, by a strip of sheet metal and whose plane runs in parallel with the plane of the door leaf. The free end of the arm is provided with the coupling part which preferably is a nose directed towards the door leaf and projecting sideways from the arm. The coupling part is stationary in its vertical position. The damper with the gripper part is fastened to the door leaf. After installation, the door leaf generally is adjusted in height to align the edges of the door leaf in parallel with the floor and the door frame. The coupling part, preferably the nose projecting sideways, is significantly bigger in the vertical direction than the gripper part of the damper, so that coupling will be effected safely irrespective of the mounting height of the door leaf or the gripper part. It is not necessary to adjust the vertical position of the coupling part or the gripper part.

According to a preferred embodiment, the arm is prestressed such that the coupling part is pushed away from the door leaf and that a cover attached in front of the runner rail forms a support for the free end portion of the arm for a defined positioning of the coupling part. The arm is resiliently flexible in a horizontal plane and it is bent outward from the plane of the door leaf, whereas the coupling part protrudes inward. Prestressed in this manner, it abuts against the profile of the cover fixed to the runner rail and forming a front lining. At the same time this lining forms a stop part for positioning the free end of the prestressed arm. Thereby, the lateral position of the coupling part, when in its waiting position, is defined and it is guaranteed that the gripper part of the damper meets the coupling part in a manner adequate to its function in order to trigger the damper.

The structural unit may be mounted to a profile rail forming the runner rail or being connected thereto. It is also possible to mount the structural unit in a displaceable (and lockable) manner.

In a preferred embodiment of the invention, the coupling part is a nose projecting sideways from the arm and lockingly engaging a recess in the gripper part of the damper. As an alternative, it is possible to provide a recess in the arm and a corresponding nose at the damper.

According to preferred embodiment of the invention, the structural unit can optionally be mounted on the right end side or the left end side, so as to cooperate with a right end side or a left end side damper or coupling part of the door leaf. This is advantageous in that a single structural unit is adapted to be selectively mounted either on the right or the left of the runner rail. To achieve this, the structural unit should be designed such that it is pivotable by 180° about the limiting device and in parallel with the plane of the door leaf, and such that it can be fastened in both positions using the same fastening elements such as holes and screws without requiring any working on the material.

The sliding door of the invention is particularly, yet not exclusively, suited as a glass sliding door. The running device is part of an upper metal holder of the glass door leaf. Thus, it is particularly advantageous, if the structural unit as a whole can be mounted in a simple manner in the correct mutual relationship of the components.

The following is a detailed description of embodiments of the invention with reference to the drawings.

In the Figures:

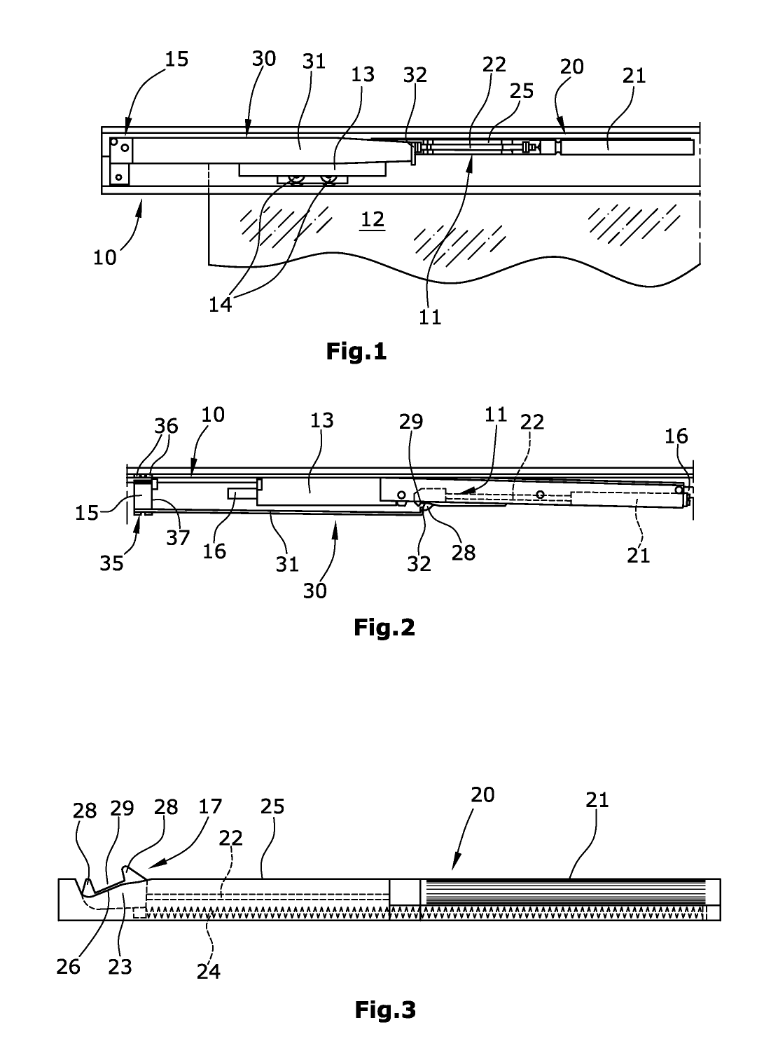

FIG. 1 is a front view of a sliding door,

FIG. 2 is a top plan view on the sliding door fitting at the moment of triggering of the damper,

FIG. 3 is a schematic illustration of the damper with withdrawal function, and

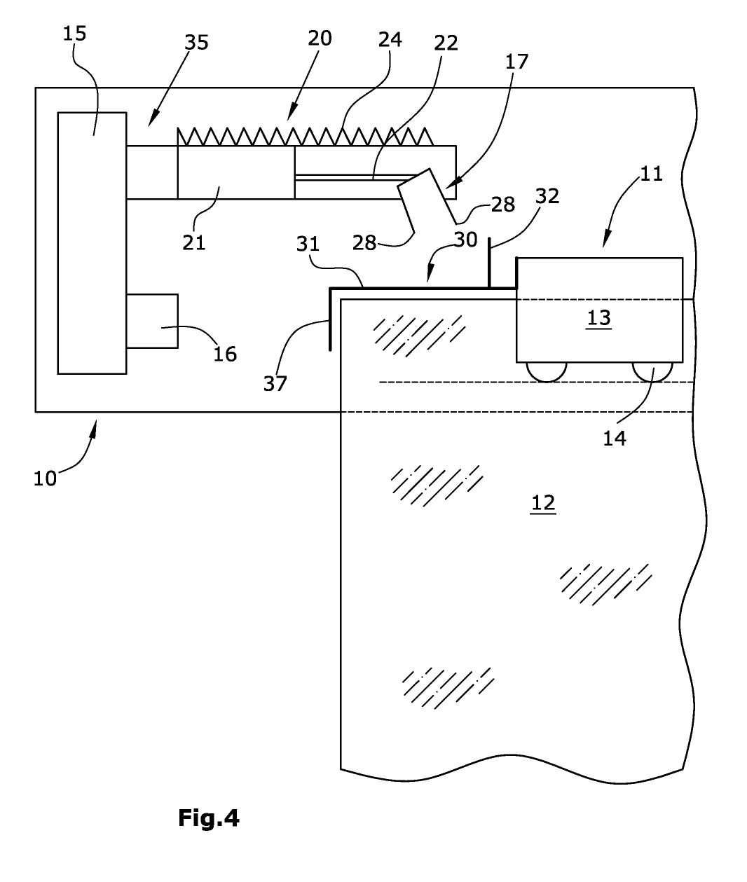

FIG. 4 illustrates a second embodiment.

Referring to FIG. 1, a runner rail 10 is provided which is mounted horizontally to a door opening and guides a door carriage 11 to which the door leaf 12 is mounted in a depending manner. In the embodiment illustrated the door carriage 11 is provided with two running devices 13 of which only one is visible. The running device 13 comprises runners 14 guided in the runner rail 10 where they roll in a frictionless manner.

At each of the two ends, the door carriage 11 is provided with a buffer stop 16 that bumps against a limiting device 15 at the end of the displacement path of the door carriage. The limiting device 15 is fastened to the runner rail 10, preferably in a displaceable and lockable manner.

The door carriage 11 comprises one or two dampers 20. FIG. 3 schematically illustrates such a damper. The damper has a cylinder 21 in which a non-illustrated piston is arranged for displacement. A piston rod 22 extends from the cylinder, at the end of which a slide 23 is fastened. A spring 24 engages the slide 23, which spring is connected to the opposite end of the cylinder 21. Thus, the spring 24 tends to pull the piston rod 22 into the cylinder 21. The slide 23 is guided in a rail 25. The latter has a cam contour 26 with a locking position in which the slide can engage the rail. In the position illustrated in FIG. 3, the slide 23 is locked at the front end position. The slide 23 forms a gripper part 17 of the damper 20. The latter has a recess 29 between two protrusions 28.

If the slide 23 is pivoted clockwise, as in FIG. 3, by pressing against the protrusion 28 from the recess 29, the slide 23 slides into a triggering position in which is freely displaceable along the rail 25 until it snaps into the recess 29.

As illustrated in FIGS. 1 and 2, the damper is fixed to the door carriage 11 such that it is accessible from the front side of the sliding door. The front side of the sliding door is provided with another coupler 30 or trigger. The same has an elongated flat arm 31 connected at one end with the limiting device 15 and carrying a transversely projecting nose 32 at the other end. The arm 31 is a flat sheet metal strip which is elastic and functions as a flexible spring. The plane of the flat arm 31 is generally parallel to the plane of the door leaf 12, i.e. vertical. In the top plan view of FIG. 2, the arm 31 is bent slightly outward (downward in the drawing) and abuts against a (non-illustrated) cover forming a front lining that covers both the runner rail 10 and the running device 13. This cover serves as a stop element for positioning the nose 32 so that the same is reliably hit by the second protrusion 28. Making the coupling part of the arm 31 and the gripper part 17 of the damper meet does not require any vertical adjustment of these elements and in particular requires no vertical adjustment of the door leaf 12. Conversely, a vertical adjustment of the door leaf likewise requires no vertical adjustment of those components.

The nose 32 cooperates with the recess 29 of the gripper part 17. FIG. 2 illustrates the engagement of the nose 32 into the recess 29. Further, it can be seen that the coupler 30 forms a structural unit 35 with the limiting device 15, which is mounted as a whole at a suitable position on the runner rail 10, using screws 36, for instance. Thus, a defined distance is guaranteed between the stop surface 37 of the limiting device and the nose 32 of the coupler 30.

The front side of the sliding door fitting, directed downward in FIG. 2, is covered with a (non-illustrated) cover that hides the coupler 30 and the door carriage 11.

It shall be assumed that the door carriage is moved manually at a considerable speed from the right to the left, as illustrated in FIGS. 1 and 2. The damper is in the state illustrated in FIG. 3 in which the gripper part 17 is advanced, whereas its slide 23 is in a slightly oblique position. The first protrusion 28 passes the nose 32 of the coupler 30. Yet, the nose 32 bumps against the more prominent protrusion 28 (FIG. 2), whereby the gripper part 17 is displaced on the cam contour 26 so that it can move along the rail 25. Due to the high speed of the door carriage, the damper 20, which is a fluid damper, causes a deceleration of the door way proportionate to the speed. At the same time, the spring 24 exerts its effect, pulling the gripper part 17 to the cylinder 21. Thereby, the cylinder 21 fastened to the door carriage is moved to the left, as illustrated in FIG. 2. Thus, the spring 24 pulls the door carriage into the closed position in which the buffer 16 bumps against the stop surface 37. In this end position of the door carriage, the spring 24 is in a relatively relaxed state. If the sliding door is opened manually thereafter, the coupler 30 first hold on to the gripper part 17 so that the spring 24 is stressed until the gripper part 17 snaps in at the outer end position (FIG. 3).

The embodiment in FIG. 4 refers to a variant in which the structural unit 35 is formed by the limiting device 15 and the damper 20, whereas the coupler 30 is mounted at the door carriage 11. At the end stop, a stop face 37 of the coupler 30 abuts against the buffer stop 16 of the limiting device 15. It is also possible to provide a rigid end stop at the limiting device 15 and a soft buffer stop at the stop face 37. The structure of the damper 20 is the same as in the first embodiment. As illustrated in FIG. 4, however, it is part of the structural unit 35 that also includes the limiting device 15. The structural unit 35 is mounted on the runner rail 10.

The coupler 30 has a nose 32 cooperating with the gripper part 17 of the damper 20 in the manner described above and causing a deceleration of the door leaf 12 at the triggering point, whereafter the door carriage is pulled into the closed position.

The embodiment in FIG. 4 can be varied such that the arm 31 is a strip of a flat material whose plane is in parallel with that of the door leaf 12. The coupling part then projects freely towards the gripper part 17 of the damper 20. In this case, this gripper part 17 is also directed horizontally, i.e. transversely to the plane of the door leaf 12.

The invention guarantees that the grippe part 17 is always triggered at the correct position of the displacement path, with the sliding door being guided exactly into its closed position. Should the door leaf still have a residual speed at the end of the damping path, the buffer stop 16 and the stop face 37 will absorb these forces. In the end position of the door leaf, there is a gap between the gripper part 17 of the damper and the nose 32 of the coupling part so that the gripper part is not loaded exceedingly. This overload protection requires an exact positioning of the nose 32, which is also guaranteed by the invention.

1.-7. (canceled)

8. A sliding door comprising a runner rail, a door leaf guided therein by means of at least one running gear, a limiting device limiting the displacement path of the door leaf, a damper with a soft-closing function fastened to the door leaf and a coupler fastened to the runner rail and interlocking with a gripper part of the damper, wherein, upon closing the door, the damper first slows down the door leaf and then moves the same into the closed position, the limiting device forming a structural unit together with the coupler, and the coupler comprising an elongated flat arm extending in parallel with the runner rail and having a coupling part for interengaging with the gripper part of the damper, wherein the arm extends in parallel with the plane of the door leaf, the coupling part extending transversely to the plane of the door leaf and projects towards the same.

9. The sliding door of claim 8, wherein the arm is elastic and functions as a flexible spring, that the coupling part is pushed away from the door leaf and that a cover set in front of the arm forms a support for the free end portion of the arm for a defined positioning of the coupling part.

10. The sliding door of claim 8, wherein the coupling part is a nose projecting from the arm, which nose snaps into a recess in the gripper part of the damper.

11. The sliding door of claim 8, wherein the structural unit is adapted to be optionally mounted on the right or the left end side of the runner rail so as to cooperate with a left or right end side damper or coupler of the door leaf.

12. The sliding door of claim 8, wherein the door leaf is a glass pane.

13. The sliding door of claim 8, wherein the structural unit is adapted to be displaced and locked on the runner rail in the longitudinal direction.
